(19) United States
(12) Patent Application Publication
(10) Pub. No.: US 2018/0020865 A1
(43) Pub. Date: Jan. 25, 2018

(54) COOKING VESSEL HAVING DETACHABLE HANDLE

(71) Applicant: POKETDREAM INC., Seoul (KR)

(72) Inventor: Kuen Sik Oh, Seoul (KR)

(21) Appl. No.: 15/523,636

(22) PCT Filed: Dec. 3, 2015
(86) PCT No.: PCT/KR2015/013128

§ 371 Date: Sep. 18, 2017

(30) Foreign Application Priority Data
Dec. 19, 2014 (KR) 10-2014-0184022

(51) Int. Cl. A47J 27/00; A47J 36/34; A47J 45/07; A47J 45/10

(52) U.S. Cl. CPC A47J 27/002; A47J 45/07; A47J 36/34; A47J 45/10

(57) ABSTRACT

The present invention relates to a cooking vessel having a detachable handle and, more particularly, to a cookset having a detachable handle, wherein the handle can be simply attached to and detached from the cookset, and the cookset is firmly fixed to the handle in a state where the handle is coupled thereto so that the cookset is firmly fixed to the handle even when the cookset is moved or flipped during cooking.

### TECHNICAL FIELD

The present invention relates to a cooking vessel having a detachable handle, and more specifically, to a cookset including a handle easily attachable to and detachable from the cookset, wherein once the handle is coupled to the cookset, the handle is firmly fixed to the portable port even when the portable port is moved or flipped during cooking.

### BACKGROUND ART

In general, cooking vessels may be used as outdoor cooking utensils, and have been widely used for cooking foods in indoor places such as homes or in outdoor places such as mountains or camping grounds.

Such a cooking vessel used for cooking food may include a vessel body and a handle coupled to the vessel body, and when in use, the cooking vessel may be placed on a burner or a gas stove after putting food into the cooking vessel and closing the cooking vessel with a lid.

For example, a cooking vessel may include a cylindrical vessel body, a handle provided on an outer surface of the body for a user to grip during cooking, and a lid provided on an upper side of the cooking vessel.

Many types of cooking vessels including detachable handles have been proposed to reduce volumes occupying the storage space or warehouse.

Detachable handles may be classified into a type disclosed in Korean Patent Application Publication No. 10-2004-0043798, in which a detachable handle fixes to a cooking vessel body by biting an upper edge of the cooking vessel body like tongs, and a type disclosed in Korean Patent No. 10-1217604, in which a detachable handle fixes to a cooking vessel body as a coupling part of the handle is coupled to another coupling part formed on a side of the cooking vessel body.

To reduce the total volume of a cooking vessel set for carrying or storing, cooking vessel sets may be nested inside one another by placing a relatively small cooking vessel inside a relatively large cooking vessel until all the other cooking vessels are inserted inside the largest cooking vessel. Since the largest cooking vessel accommodates all the other cooking vessels, a user may easily carry all cooking vessels of a cooking vessel set as if the user carries only one big cooking vessel.

Therefore, cooking vessels have been manufactured to have fewer and closely contacting protrusions in order to minimize the total volume of cooking vessels and improve spatial efficiency when storing the cooking vessels by placing a relatively small cooking vessel inside a relatively large cooking vessel.

However, a handle of the type disclosed in Korean Patent Application Publication No. 10-2004-0043798 has a complicated structure because the handle fixes to a cooking vessel body by biting an upper edge of the cooking vessel body like tongs, and is also not hygenically unacceptable because a portion of the handle located inside the cooking vessel body may be in contact with food being cooked. In addition, the handle is not attachable or detachable after a lid is put on the cooking vessel body.

In addition, a handle of the type disclosed in Korean Patent No. 10-1217604 may be detached from a cooking vessel body when the cooking vessel is flipped, and the cooking vessel has a large volume because of a large coupling part formed on the cooking vessel body. Furthermore, the handle of this type is not easily attached to and detached from the cooking vessel body.

### DISCLOSURE OF THE INVENTION

### Technical Problem

An object of the present invention is to provide a cooking vessel including a handle easily detachable from the cooking vessel to reduce the overall volume of the cooking vessel and easily carry the cooking vessel, wherein once the handle is attached to the cooking vessel, the handle is firmly fixed to the cooking vessel even when the cooking vessel is moved or flipped during cooking.

### Technical Solution

A detachable-handle-type cooking vessel of the present invention includes a cooking vessel body and a cooking vessel handle.

The cooking vessel body includes a V-shaped insertion coupling part protruding from a side portion of the cooking vessel body, a circular fixing plate extending from the V-shaped insertion coupling part, and a recess concavely formed in a center portion of the circular fixing plate.

The cooking vessel handle is a reverse L-shaped plate including a grip part for a user to grip, a V-shaped hole defined in a bent portion extending from the grip part, and an open hole defined in a front portion of the grip part,

A fixing slide having a reverse L-shape is provided on the open hole of the cooking vessel handle 20. The fixing slide includes a fixing slide lower part provided on a lower side of the open hole of the cooking vessel handle, a sloped part extending from the fixing slide lower part and slidable on the circular fixing plate, a projection stopper extending from the sloped part and fixing the cooking vessel handle when inserted into the recess, and a connection part extending from the fixing slide lower part and inserted through the open hole, and a slide operation part connected to the connection part and located above the open hole.

The cooking vessel may further include magnets respectively arranged at a rear side of the open hole and a rear side of the connection part to push the connection part forward.

The cooking vessel may further include an elastic part provided between a rear side of the open hole and a rear side of the connection part to push the connection part forward.

### Advantageous Effects

According to the present invention, a cooking vessel body and a cooking vessel handle of a cooking vessel are separable such that the cooking vessel may be easily carried. The handle is easily detachable from the cooking vessel body by pushing a slide operation part backward and then pushing a grip part downward. The cooking vessel and the handle may be fixed to each other without being shaken left and right owing to a V-shaped insertion coupling part and a V-shaped hole. Even when the cooking vessel is lifted upward using the handle, the handle is not detached and is maintained in a fixed state by a lower end portion of the V-shaped hole. A projection stopper prevents the handle from being unintentionally detached from the cooking vessel when the cooking vessel is put down and prevents the handle from being detached from the cooking vessel body even when a user flips the cooking vessel while holding the handle.

### BRIEF DESCRIPTION OF THE DRAWINGS

FIG. 1 is a perspective view illustrating an embodiment of the present invention.

FIG. 2 is a side view illustrating an embodiment of the present invention.

FIG. 3 is a view illustrating a usage state according to an embodiment of the present invention.

FIG. 4 is a cross-sectional view illustrating an embodiment of the present invention.

FIG. 5 is a cross-sectional view illustrating an embodiment of the present invention.

FIG. 6 is a cross-sectional view illustrating an embodiment of the present invention.

FIG. 7 is a partial phantom view illustrating an embodiment of the present invention.

FIG. 8 is a partial phantom view illustrating an embodiment of the present invention.

FIG. 9 is a partial phantom view illustrating an embodiment of the present invention.

FIG. 10 is a partial phantom view illustrating an embodiment of the present invention, FIG. 11 is a partial phantom view illustrating an embodiment of the present invention, and FIG. 12 is a partial phantom view illustrating a state in which the cooking vessel handle and the fixing slide are coupled to the cooking vessel body according to an embodiment of the present invention.

### MODE FOR CARRYING OUT THE INVENTION

Preferred embodiments of the present invention will now be described in detail with reference to the accompanying drawings. However, various changes in form and details may be made within the scope of the present invention, and the scope of the present invention is not limited to the embodiments described below. The embodiments are provided so that this disclosure will be thorough and complete, and will fully convey the scope of the invention to those of ordinary skill in the art. In the drawings, the shapes and dimensions of elements may be exaggerated for clarity, and like reference numerals denote like elements.

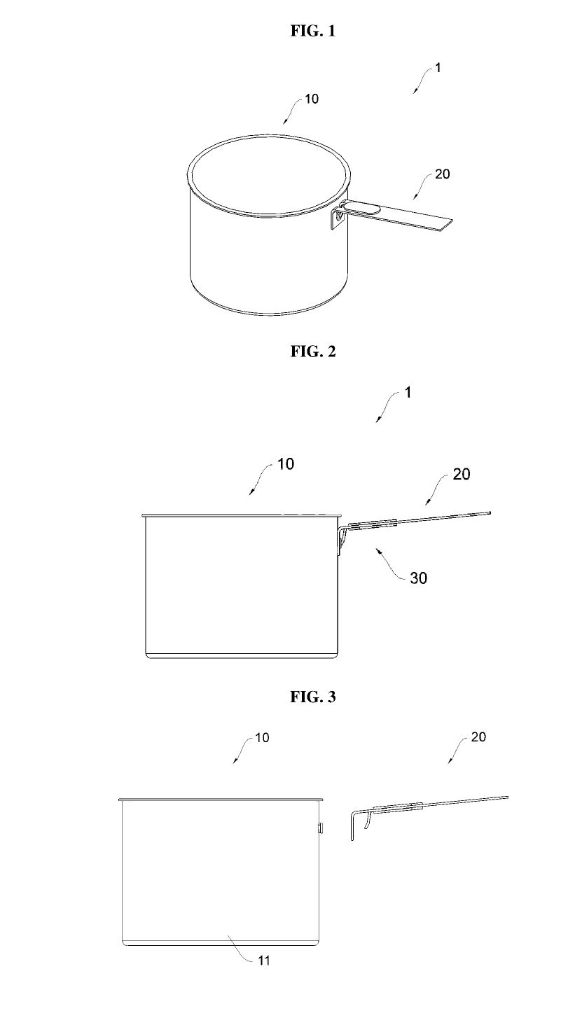

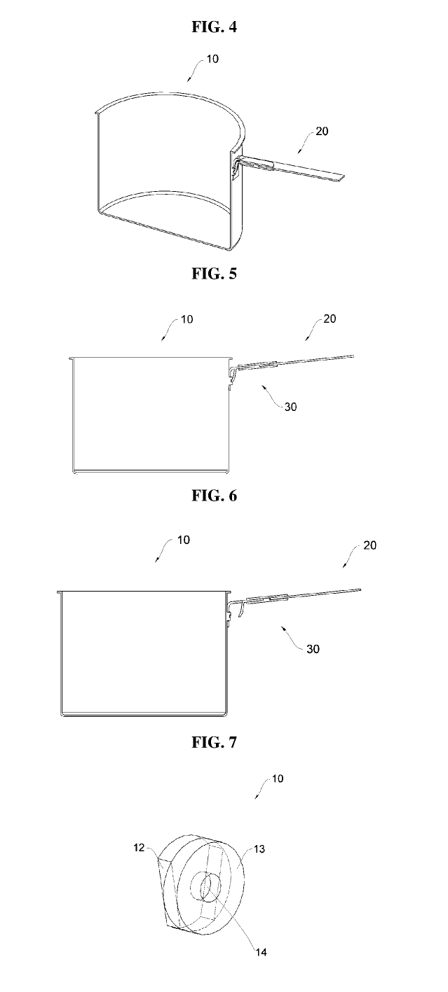

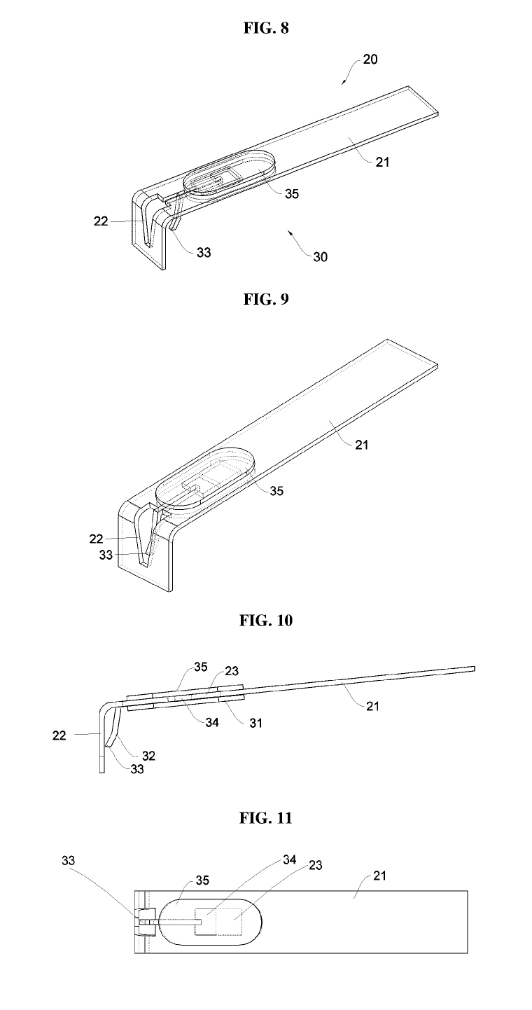

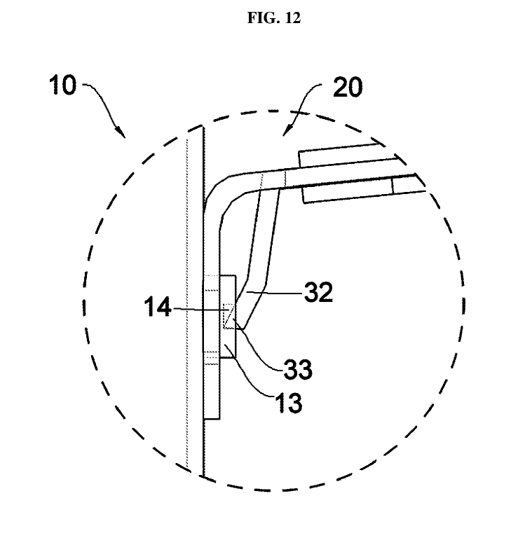

FIG. 1 is a perspective view illustrating an embodiment of the present invention. FIG. 2 is a side view illustrating an embodiment of the present invention. FIG. 3 is a side view illustrating a usage state in which a cooking vessel handle 20 is separated from a cooking vessel body 10 according to an embodiment of the present invention. FIGS. 4 to 6 are cross-sectional views illustrating embodiments of the present invention. FIG. 7 is an enlarged phantom view of a portion of the cooking vessel body 10 according to an embodiment of the present invention. FIGS. 8 to 11 are phantom views illustrating the cooking vessel handle 20 and a fixing slide 30 according to embodiments of the present invention. FIG. 12 is a partial phantom view illustrating a state in which the cooking vessel handle 20 and the fixing slide 30 are coupled to the cooking vessel body 10 according to an embodiment of the present invention.

Referring to FIGS. 1 to 12, a detachable-handle-type cooking vessel of the present invention includes the cooking vessel body 10, the cooking vessel handle 20, and the fixing slide 30.

The cooking vessel body 10 includes a container part 11, a V-shaped insertion coupling part 12 protruding from a side portion of the container part 11, a circular fixing plate 13 extending from the V-shaped insertion coupling part 12, and a recess 14 concavely formed in a center portion of the circular fixing plate 13. In an embodiment of the present invention, the cooking vessel has a general pot shape. However, the cooking vessel may have any other cooking utensil shape such as a frying pan shape.

The cooking vessel handle 20 is a reverse L-shaped plate including a grip part 21 for a user to grip, a V-shaped hole 22 defined in a bent portion extending from the grip part 21, and an open hole 23 defined in a front portion of the grip part 21. In an embodiment of the present invention, the grip part 21 has a long bar shape. However, the grip part 21 of the cooking vessel handle 20 may have another shape such as a wide shape or an elliptical shape.

The fixing slide 30 is provided on the open hole 23 of the cooking vessel handle 20. The fixing slide 30 includes a fixing slide lower part 31 provided on a lower side of the open hole 23 of the cooking vessel handle 20, a sloped part 32 extending from the fixing slide lower part 31 and slidable on the circular fixing plate 13, a projection stopper 33 extending from the sloped part 32 and fixing the cooking vessel handle 20 when inserted into the recess 14, a connection part 34 extending from the fixing slide lower part 31 and inserted through the open hole 23, and a slide operation part 35 connected to the connection part 34 and located above the open hole 23.

A recess is defined in a front portion of the connection part 34, and the sloped part 32 having a fin shape is inserted in the recess and extends. A portion of the sloped part 32 extending from the recess is fixed between the fixing slide lower part 31 and the slide operation part 35 so as not to be vertically shaken. A linear hole extending from the open hole 23 may be defined in the cooking vessel handle 20 to receive the extending portion of the sloped part 32 and prevent the extending portion of the sloped part 32 from shaking left and right.

Magnets may be respectively arranged at a rear side of the open hole 23 and a rear side of the connection part 34 in such a manner that sides of the magnets having the same polarity face each other to push the connection part 34 forward. In this case, force is always applied to the fixing slide 30 in a forward direction such that the cooking vessel and the cooking vessel handle 20 may be maintained in a fixed state. When the slide operation part 35 is pushed backward to detach the cooking vessel handle 20, locking is released as the projection stopper 33 departs from the recess, and if a user separates his/her finger from the slide operation part 35, the fixing slide 30 is moved forward again by the magnetic force of the magnets.

In this case, magnets or a magnet and a magnetic material may be arranged at a front side of the open hole 23 and a front side of the connection part 34 so as to maintain the fixing slide 30 in a fixed state at a front side by attraction between the magnets or the magnet and the magnetic material.

Instead of using the magnetic material, an elastic part may be used to obtain the same effect.

The cooking vessel may be used as follows according to an embodiment of the present invention.

According to an embodiment of the present invention, as shown in FIG. 3, the cooking vessel handle 20 and the cooking vessel body 10 are usually stored or carried in a separated state.

When in use for cooking, the cooking vessel handle 20 is horizontally pushed inward while holding the grip part 21 of the cooking vessel handle 20 so as to insert the circular fixing plate 13 and the V-shaped insertion coupling part 12 into a widely opened upper side of the V-shaped hole 22, and then the cooking vessel handle 20 is vertically pushed upward so as to further insert the V-shaped insertion coupling part 12 along the V-shaped hole 22.

At this time, the cooking vessel handle 20 is pushed upward until the projection stopper 33 is inserted into the recess 14. The fixing slide 30 is moved backward as the sloped part 32 is slid while being pushed by the circular fixing plate 13, and is then moved forward again at the time the projection stopper 33 is inserted into the recess 14 with a clicking sound, thereby fixing the cooking vessel handle 20 to the cooking vessel body 10.

In the above-described fixed state, a user may cook food in the cooking vessel 1 while shaking the cooking vessel 1 using the grip part 21 of the cooking vessel handle 20, and may flip the cooking vessel 1 using the grip part 21 so as to take the food out of the cooking vessel 1.

When the cooking vessel 1 is stored after cooking, the cooking vessel handle 20 may be separated from the cooking vessel body 10 by pushing the cooking vessel handle 20 down in a vertical direction while pulling the slide operation part 35.

The scope of present invention is not limited to the above-described embodiments and the accompanying drawings but is defined by the appended claims. Those of ordinary skill in the art may make various replacements, modifications, or changes without departing from the scope of the present invention defined by the appended claims, and these replacements, modifications, or changes should be construed as being included in the scope of the present invention.

1. A cooking vessel for cooking food, the cooking vessel comprising:
a cooking vessel body comprises:
a V-shaped insertion coupling part protruding from a side portion of the cooking vessel body;
a circular fixing plate extending from the V-shaped insertion coupling part; and
a recess concavely formed in a center portion of the circular fixing plate; and
a cooking vessel handle, the cooking vessel handle is a reverse L-shaped plate and comprises:
a grip part for a user to grip;
a V-shaped hole defined in a bent portion extending from the grip part;
an open hole defined in a front portion of the grip part; and
a fixing slide having a reverse L-shape is provided on the open hole of the cooking vessel handle, the fixing slide comprises:
a fixing slide lower part provided on a lower side of the open hole of the cooking vessel handle;
a connection part extending from the fixing slide lower part and inserted through the open hole;
a fin-shaped sloped part extending from the connection part and slidable on the circular fixing plate;
a projection stopper extending from the fin-shaped sloped part and fixing the cooking vessel handle when inserted into the recess; and
a slide operation part connected to the connection part and located above the open hole.

2. The cooking vessel of claim 1, further comprising:
a recess defined in a front portion of the connection part; and
a linear hole extending from the open hole is defined in the cooking vessel handle to receive the extending portion of the fin-shaped sloped part and prevent the extending portion of the fin-shaped sloped part from shaking left and right,
wherein the fin-shaped sloped part is inserted in the recess and extends and a portion of the fin-shaped sloped part extending from the recess is fixed between the fixing slide lower part and the slide operation part so as not to be vertically shaken; and

3. The cooking vessel of claim 1, further comprising magnets respectively arranged at a rear side of the open hole and a rear side of the connection part in such a manner that sides of the magnets having the same polarity face each other to push the connection part forward.

4. The cooking vessel of claim 1, further comprising an elastic part provided between a rear side of the open hole and a rear side of the connection part to push the connection part forward.

5. The cooking vessel of claim 1, further comprising a magnet and a magnetic material arranged between a front side of the open hole and a front side of the connection part to pull the connection part forward.

6. The cooking vessel of claim 2, further comprising magnets respectively arranged at a rear side of the open hole and a rear side of the connection part in such a manner that sides of the magnets having the same polarity face each other to push the connection part forward.

7. The cooking vessel of claim 2, further comprising an elastic part provided between a rear side of the open hole and a rear side of the connection part to push the connection part forward.

8. The cooking vessel of claim 2, further comprising a magnet and a magnetic material arranged between a front side of the open hole and a front side of the connection part to pull the connection part forward.

9. A cooking vessel for cooking food, the cooking vessel comprising:
a cooking vessel body comprises:
a V-shaped insertion coupling part protruding from a side portion of the cooking vessel body;
a circular fixing plate extending from the V-shaped insertion coupling part; and
a recess concavely formed in a center portion of the circular fixing plate; and
a cooking vessel handle comprises:
a grip part having a bent portion;
a V-shaped hole defined in the bent portion;
an open hole defined in a front portion of the grip part; and
a fixing slide having a reverse L-shape is provided on the open hole of the cooking vessel handle, the fixing slide comprises:
a fixing slide lower part provided on a lower side of the open hole;
a connection part extending from the fixing slide lower part and inserted through the open hole;
a fin-shaped sloped part extending from the connection part and slidable on the circular fixing plate; and
a slide operation part connected to the connection part and located above the open hole.

10. The cooking vessel of claim 9, further comprising:
a recess defined in a front portion of the connection part; and
a linear hole extending from the open hole is defined in the cooking vessel handle to receive the extending portion of the fin-shaped sloped part and prevent the extending portion of the fin-shaped sloped part from shaking left and right,
wherein the fin-shaped sloped part is inserted in the recess and extends and a portion of the fin-shaped sloped part extending from the recess is fixed between the fixing slide lower part and the slide operation part so as not to be vertically shaken; and

11. The cooking vessel of claim 9, further comprising magnets respectively arranged at a rear side of the open hole and a rear side of the connection part in such a manner that sides of the magnets having the same polarity face each other to push the connection part forward.

12. The cooking vessel of claim 9, further comprising an elastic part provided between a rear side of the open hole and a rear side of the connection part to push the connection part forward.

13. The cooking vessel of claim 9, further comprising a magnet and a magnetic material arranged between a front side of the open hole and a front side of the connection part to pull the connection part forward.

14. The cooking vessel of claim 10, further comprising magnets respectively arranged at a rear side of the open hole and a rear side of the connection part in such a manner that sides of the magnets having the same polarity face each other to push the connection part forward.

15. The cooking vessel of claim 10, further comprising an elastic part provided between a rear side of the open hole and a rear side of the connection part to push the connection part forward.

16. The cooking vessel of claim 10, further comprising a magnet and a magnetic material arranged between a front side of the open hole and a front side of the connection part to pull the connection part forward.
